(19) United States
(12) Patent Application Publication
(10) Pub. No.: US 2019/0108256 A1
(43) Pub. Date: Apr. 11, 2019

(54) SYSTEM FOR SCALABLE DATABASE SECURITY

(71) Applicant: SWITCH COMMERCE, LLC, IRVING, TX (US)

(72) Inventors: DANNY ESTES, Irving, TX (US); DAVE ROSENFELD, Irving, TX (US); GREG WALKER, Irving, TX (US); JON-ERIC DINSMORE, Irving, TX (US); WILLIAM ROTON, Irving, TX (US)

(21) Appl. No.: 16/155,717

(22) Filed: Oct. 9, 2018

Related U.S. Application Data
(60) Provisional application No. 62/570,020, filed on Oct. 9, 2017.

(51) Int. Cl. G06F 17/30; G06F 21/62

(52) U.S. Cl. CPC G06F 17/30433; G06F 17/30522; G06F 17/30592; G06F 21/6227

(57) ABSTRACT

The invention pertains to a system for scalable database security which utilizes dynamically-generated queries to restrict any requests to searching through only that data which a user has permission to access. By using user-permissions to dynamically generate the queries, risk of unintended data disclosure is limited and system resources are more effectively used.

### CITATION TO PRIOR APPLICATIONS

The present application claims priority for purposes of this application to U.S. Provisional Application Ser. No. 62/570,020, entitled “SYSTEM FOR SCALABLE DATABASE SECURITY” and filed Oct. 9, 2017.

### BACKGROUND OF THE INVENTION

Within the world of business management, ease of access, production, and security of relevant business data analytics has become increasingly important to maximize profitability and remain a competitive market force. In furtherance of this need for a more flexible and scalable security solution for accessing and digesting the huge quantities of information that even a single data endpoint may generate, the present invention describes a system of data endpoints, databases, and user endpoints coordinated through a novel approach to system security. Security and user-directed customizability are achieved through generation of dynamic MDX (Multidimensional Expressions) queries run against a multidimensional database (“MDB”). Security achieved through use of the query-generation process provides benefits not seen in the prior art.

Prior art approaches to creating a secure system for aggregation and review of large quantities of data include an MDB, created with SSAS (SQL Server Analysis Services), using LDAP (lightweight directory access protocol) to interface with an implementation of Microsoft's Active Directory service. One of the key advantages of the present invention over this and other, similar approaches is improved flexibility and scalability when it comes controlling data access. The LDAP approach relies on a more conventional set of “roles” that define the type of access a particular user has with a set of predetermined permissions. The system then restricts access based on these permissions—where certain permissions effectively act as a “key” into protected data.

While this approach to limiting access to data is generally effective for systems in which roles are well-defined and static with respect to the permissions associated therewith, something more robust is needed for those systems in which roles change over time or in which a user has need of creating various “sub-user” role categories that each have different subsets of the original user's own permissions. The prior art does not disclose this type of dynamic security hierarchy. Additionally, this flexibility must permeate every layer of the user endpoint-database interactions in order to ensure that any updated, or newly created, permissions are considered for subsequent queries to the database. The prior art fails to disclose a system which is capable of the same degree of flexibility and security as disclosed by the present invention.

### SUMMARY OF THE INVENTION

An object of the present invention is to provide for a system of scalable database security that dynamically constructs search queries from a controlled set of user permissions. Another object of the present invention is to maximize system resource-utilization efficiency.

To achieve these objectives, the present invention describes queries that are dynamically structured to include only those datasets a user is permitted to view. These dynamically structured queries minimize risk of unintended disclosure of secure information as no restricted data is even searched. Furthermore, system resources are more efficiently utilized as the query only populates results with those datasets a user is permitted to see as opposed to prior art systems in which a search is performed across an entire database (restricted data included) and later filtered.

### DESCRIPTION OF THE DRAWINGS

FIG. 1 is a code sample of how to pull the list of measures a user can see according to one embodiment of the present invention.

FIG. 2 is a code sample of how to pull the list of slicers that a user can see.

FIG. 3 is a code sample of how to pull the list of filters a user can see.

FIG. 4 is a code sample of how to apply any relevant filters.

FIG. 5 is a code sample of how to exclude filter limitations for administrators.

FIG. 6 is a code sample of how to filter a particular data set (relating to ATM terminals in this embodiment) to that data the user has permission to see.

FIG. 7 is a code sample of how to filter a particular data set (relating to partners in this embodiment) to that data the user has permission to see

FIG. 8 is a code sample of how to filter a particular data set (relating to ISOs in this embodiment) to that data the user has permission to see.

FIG. 9a-9f is a code sample of how to dynamically generate an MDX query.

FIG. 10 is a set of dimensions and measures for a multidimensional database according to one embodiment.

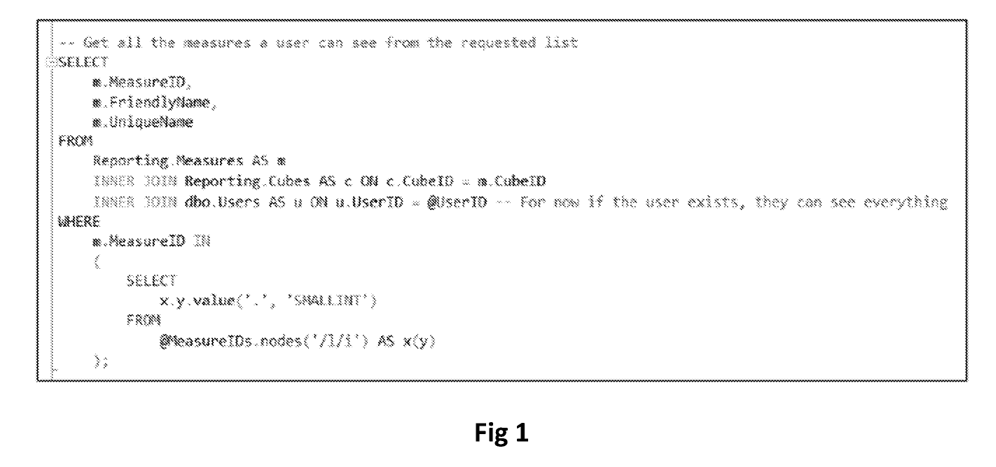

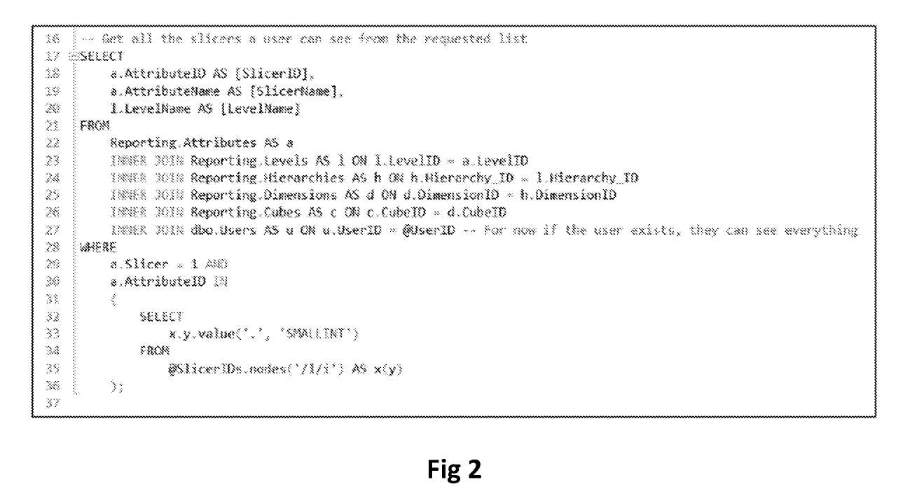

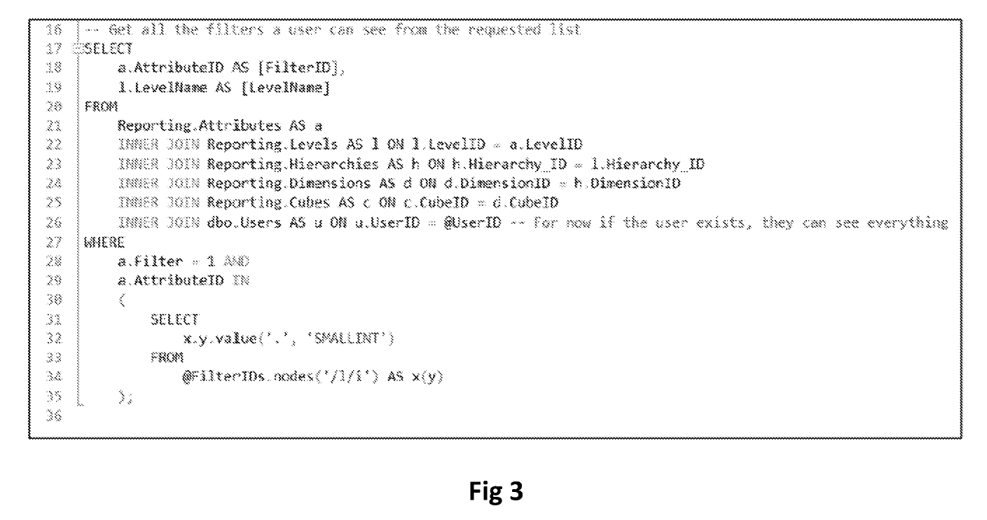

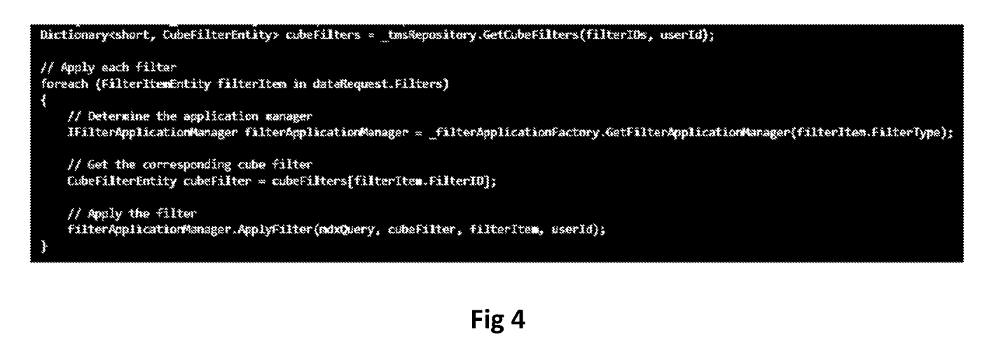

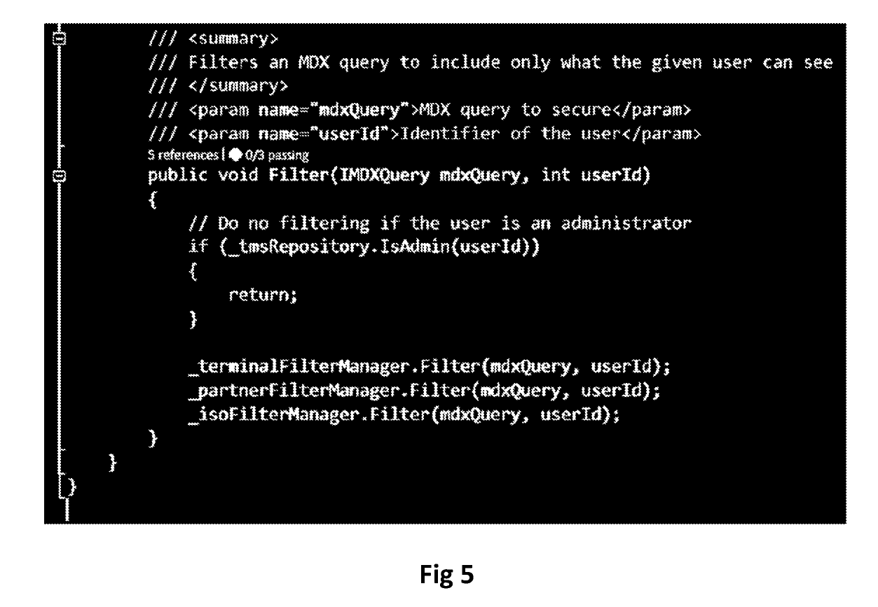

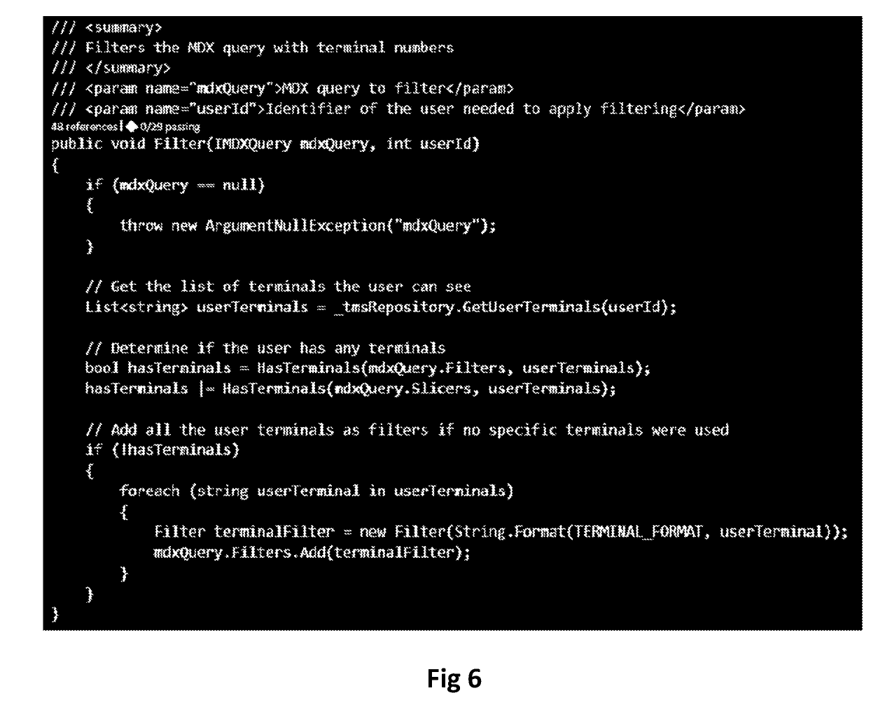

### DETAILED DESCRIPTION

To ensure a clear understanding of the present invention, it will be described in the context of a terminal management system for ATM (automated teller machine) terminals that relay information to databases for storing and filtering the aggregated information for presentation to the user based on user-specified criteria selected on a web or mobile application. A person of ordinary skill in the art would recognize that any number of similar data collection terminals could be used in place of an ATM. Additionally, users may connect with the databases through other, equivalent means, such as software run on a personal computer that operates independent from a web browser.

Within the terminal management system that is the subject of this present invention, each ATM acts as a data endpoint collecting information related to the particular terminal's usage. Transactional data including times of access events, the types of services provided during such access events, and the amount of money deposited or dispensed during such access events is stored. Other, similar information may also be stored and eventually relayed to the database as needed. The ATM has internal memory for storage of both data and program instructions. Program instructions include those which direct communication of transaction data to an external source (for example, a banking institution or database) via wired or wireless communication technologies. Such instructions also include those directed to the general functioning of the ATM. These functionalities, and implementation techniques thereof, are well-known in the art. This internal memory may consist of memory components that are volatile, nonvolatile, or a combination of both.

In one embodiment, transaction data is transmitted both to a banking institution to complete the transaction and to a transactions database (“TDB”) on a per transaction basis. The TDB is a relational database. Data from the TDB is communicated to the MDB at set intervals via an ETL (Extract Transform and Load) process using SSIS (SQL Server Integration Services).

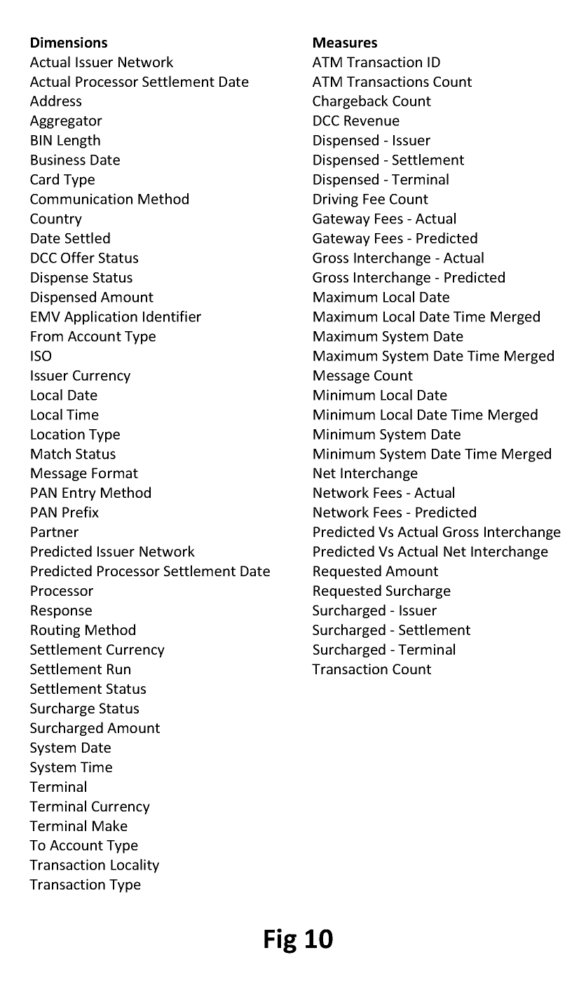

In one embodiment, the MDB will be structured with the dimensions and measures included in FIG. 10. A person of ordinary skill in the art would recognize that dimensions and measures may vary depending on the particular system's needs. The MDB is created, maintained, and updated through techniques well-known in the art.

In one embodiment, users will request data from the MDB through a web-based interface or a mobile application which requires authenticated user credentials to access. These user credentials, along with user-specific permission sets, will be stored in a user database (“UDB”). The UDB is a relational database. The interface (web or mobile) presents the user with options representing the various attributes contained in the MDB. The user may select desired attributes to have data reported on. The attributes are then processed into an MDX query that will be subsequently run against the database. The MDX query-generation process also involves program logic which parses through the UDB to identify user-specific “filters” from that user's permission sets. A user's permission sets relate to what dimensions and measures of the MDB the user has access to.

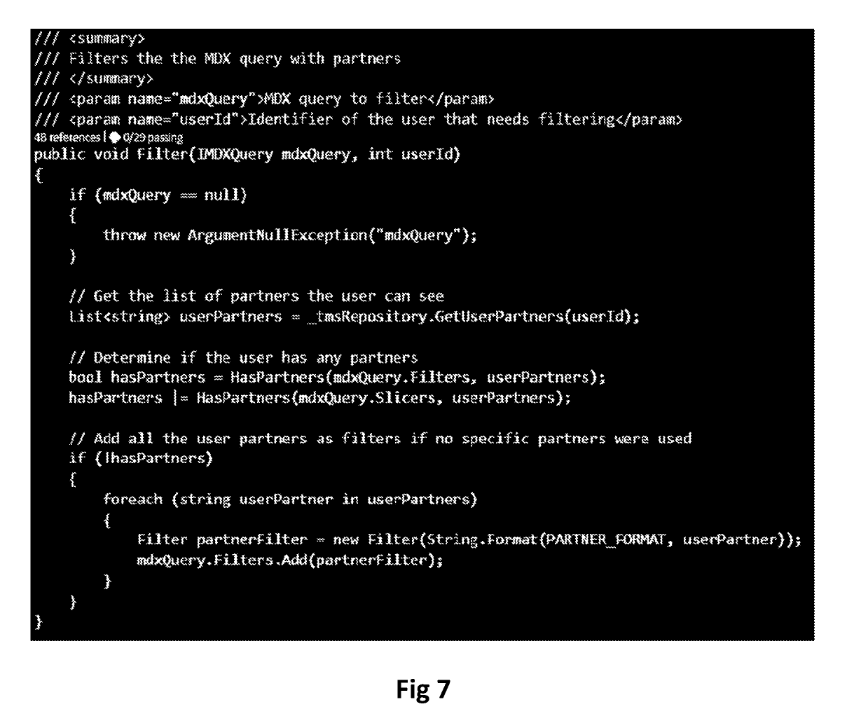

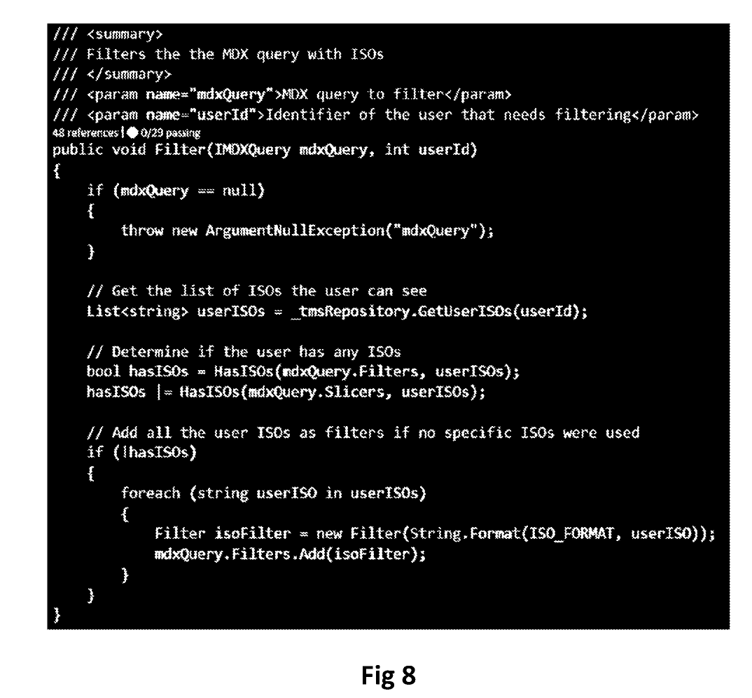

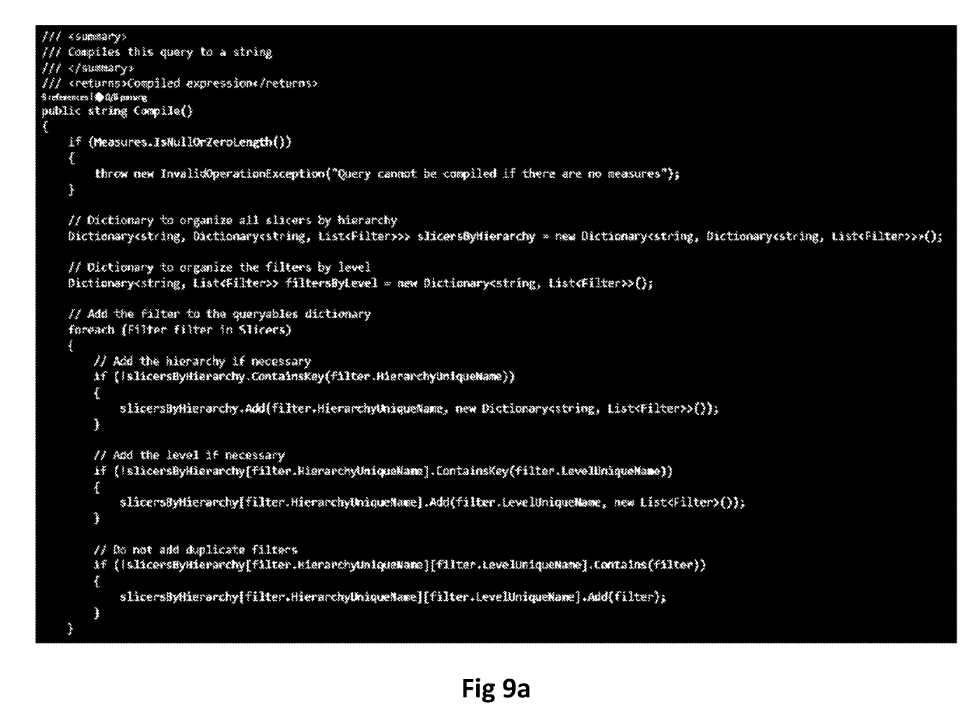

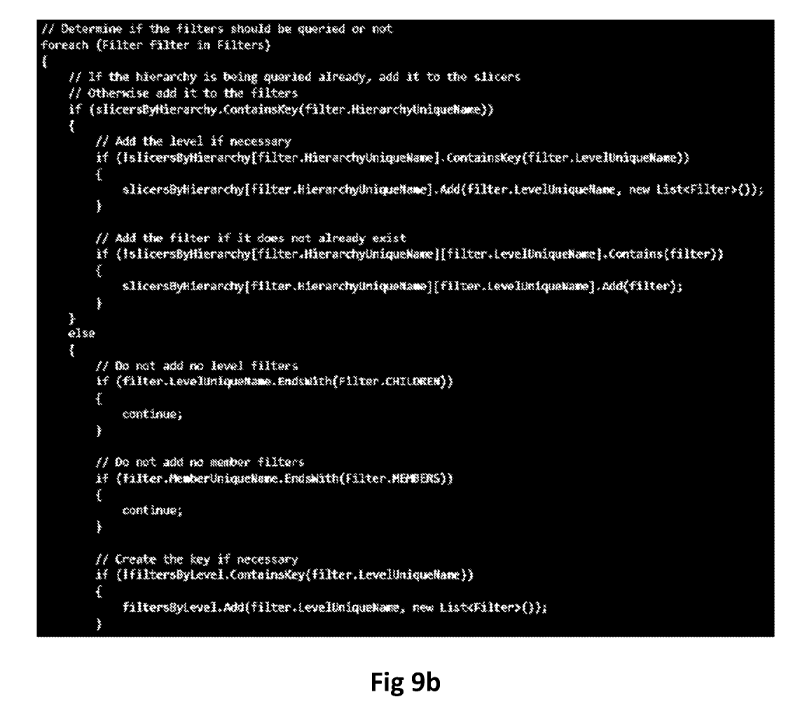

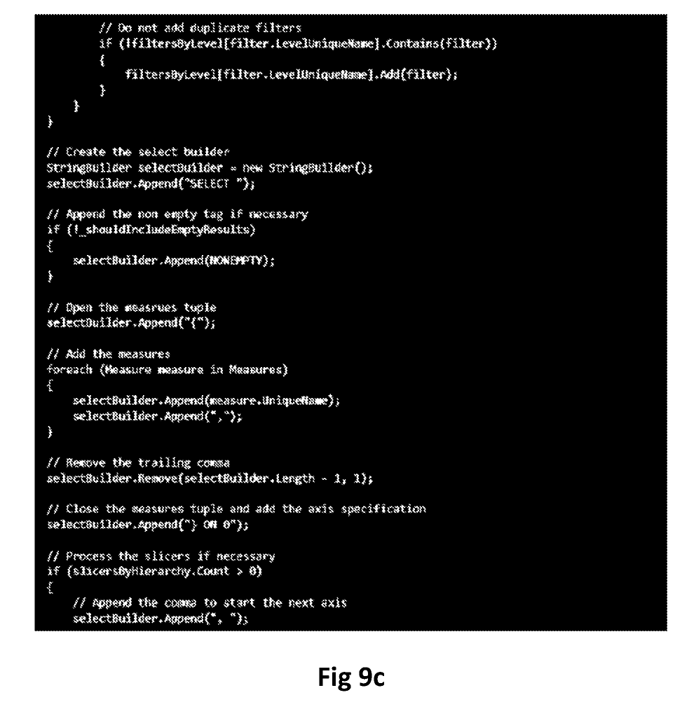

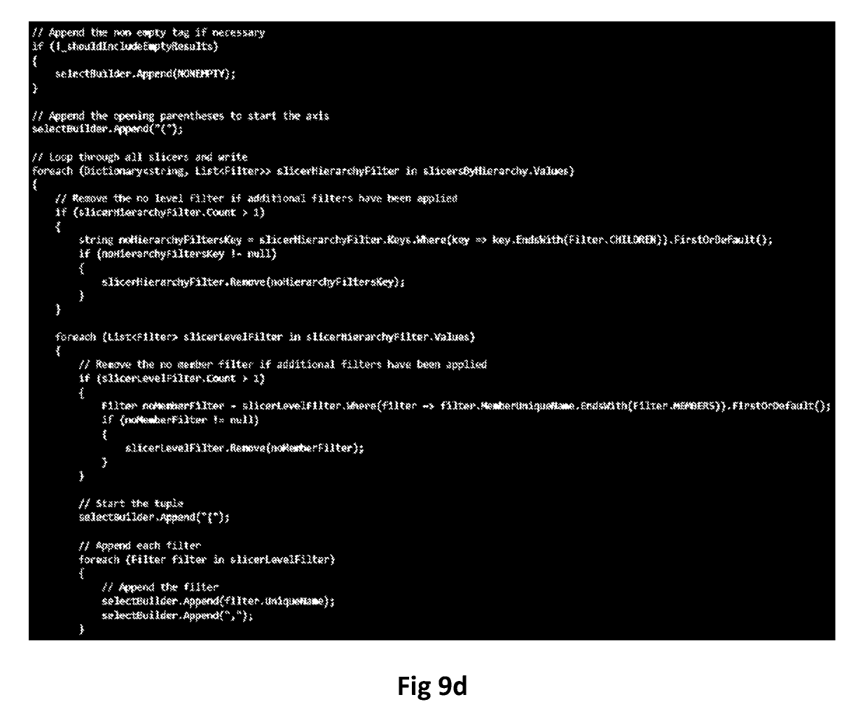

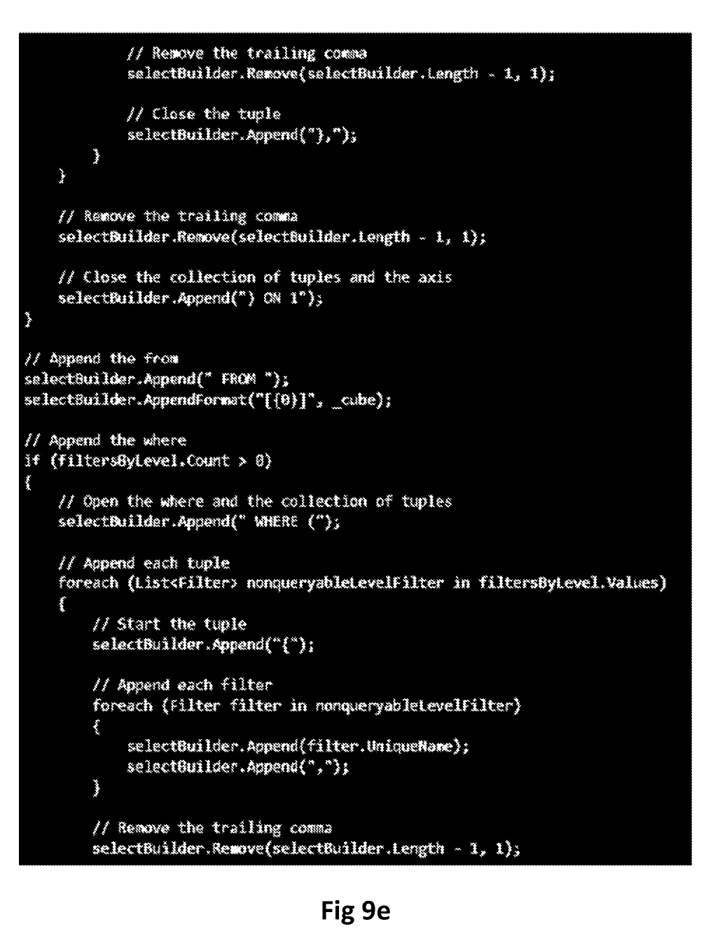

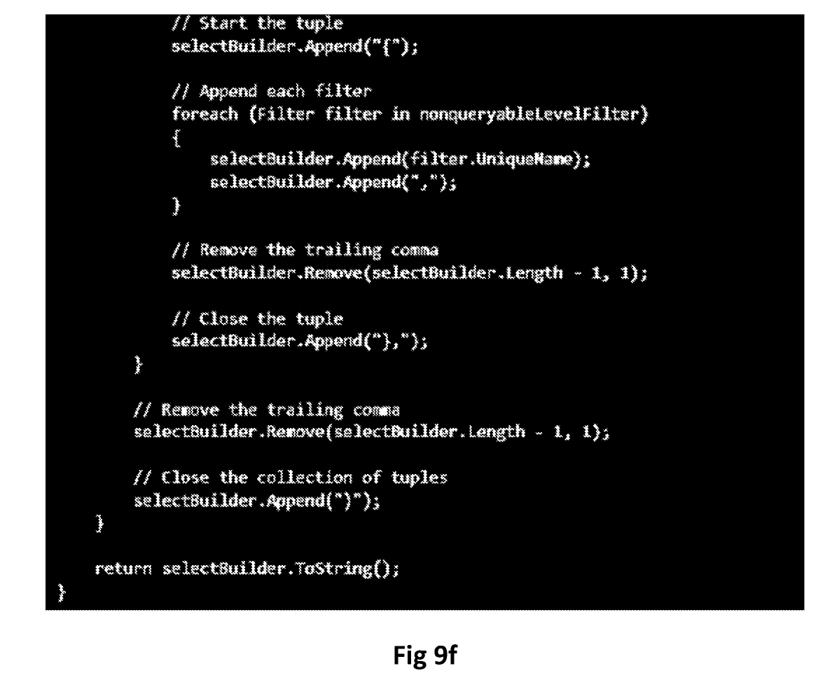

For example, in one embodiment, the UDB contains a set of “Partners” (dimension in FIG. 10) associated with a particular user ID denoting that user's access. The MDX query-generation process will parse this set of Partners as shown in FIG. 7 to first populate a string-formatted list that will then be traversed and added as filters to create the final MDX syntax shown in FIG. 9 that will be run against the MDB. These permission sets are essential to the customizable and scalable security options of the present invention's design.

When a user first logs into the system (via web or mobile software), the UDB is scanned to verify that said user's credentials are present and correct through techniques well-known in the art. Verified users are then able to select criteria (derived from the MDB's dimensions and measures) through the software's interface that will comprise portions of the MDX query later run against the MDB. If a query is made by a verified user, the program logic begins formulating a string statement with appropriate MDX syntax that reflects the user-selected attributes for which they want data reported. These selections will effectively acts as filters of the MDB's entire data set. The security measures described above, involving the user-specific permission sets, also takes place here. To avoid any duplicative filters, techniques for such a purpose well-known in the art may be implemented in the MDX query-generation process.

In one embodiment, certain users may be accorded “administrative user” abilities that allows said administrative user to create “sub-users” that have access to a subset of data to which the original user has access. The administrative user accounts will be established by system administrators. The UDB may contain the relation of a user and its set of sub-users. Each administrative user will be able, through the web or mobile software interface, to assign some subset of said administrative user's permissions to a sub-user's various permission sets. When an administrative user adds a permission to a sub-user, the UDB will be updated to reflect this change by adding said permission to the sub-user's relevant permission set. This provides for flexible and scalable security that is user-customizable and yet unseen in the prior art.

Unlike prior art approaches which tend to exclude data from user access, the present approach is more akin to specifically granting a user access to items they are permitted to view. This is why the dynamic MDX query-generation process is so essential to data security in this system. When creating the MDX query, each of said user's permission sets is traversed and incorporated into the query. The user will be unaware of this security protocol—they will see the data they are permitted to see and have no manner in which to access, or even query, elements that are not contained in the relevant permission sets.

In terms of additional scalability, a person of ordinary skill in the art would recognize that this approach to security can be implemented in many different kinds of data environments. So long as there is a link between an MDB and UDB in the form of permission sets, the dynamic security provided through the MDX query-generation process as described here may be implemented with very little, if any, modification of the program logic. A person of ordinary skill of the art would further recognize that this security strategy may also be implemented in a variety of ways. The focus is on maintaining customizable permission sets, for each user, that are used in the generation of queries to an MDB and result in seamless, secure data access.

Regarding the presentation of a query's resulting dataset, in one embodiment, once the MDX query has been fully generated, it is run against the MDB, and the resultant dataset is returned as JSON formatted information and/or JSON formatted information organized as Google data charts. The web or mobile application then parses the information and will present the data in a format selected by the user—graphical, textual, etc. Organization of data as described and the parsing thereof is well-known in the art. A person of ordinary skill in the art would understand that the implementation will vary depending on a particular system's specifications.

1. A system for data security comprising:
a multidimensional database comprising a plurality of protected data fields;
a user database comprising at least one user permission set, wherein said at least one user permission set is configured to store query-generation data, said query-generation data corresponding to a subset of said plurality of protected data fields.

2. The system of claim 1 wherein said query-generation data is used to generate a user-specific query capable of being run against said multidimensional database.

3. The system of claim 2 wherein said query-generation data comprises string values.

4. The system of claim 3 wherein said user-specific query is constructed from said string values.

5. The system of claim 4 wherein said user-specific query is limited to searching only said protected data fields corresponding to said string values.

6. The system of claim 1 further comprising an online database search interface through which said user may access said multidimensional database, wherein said online database search interface is configured to generate a user-specific query to run against said multidimensional database, said user-specific query including said query-generation data of said user.

7. The system of claim 3 wherein said multidimensional database is configured to report searched data corresponding to said subset of said plurality of protected data fields identified in said user-specific query.
